(19) United States
(12) Patent Application Publication
(10) Pub. No.: US 2026/0112230 A1
(43) Pub. Date: Apr. 23, 2026

(54) LOTTERY DEVICE AND GAME DEVICE

(71) Applicant: SEGA CORPORATION, Tokyo (JP)

(72) Inventors: Takayuki Hoshino, Tokyo (JP); Satoshi Doi, Tokyo (JP)

(73) Assignee: SEGA CORPORATION, Tokyo (JP)

(21) Appl. No.: 19/427,238

(22) Filed: Dec. 19, 2025

Related U.S. Application Data
(63) Continuation of application No. PCT/JP2024/006640, filed on Feb. 22, 2024.

(30) Foreign Application Priority Data
Jun. 29, 2023 (JP) 2023-107329

(51) Int. Cl. G07F 17/32

(52) U.S. Cl. CPC G07F 17/3216; G07F 17/3262; G07F 17/329; G07F 17/3297

(57) ABSTRACT

A lottery device includes: a lottery medium that includes a lottery surface on which a lottery content is displayed; a rotary disk on which the lottery medium is placed; and a rotary driver that rotates the rotary disk such that the lottery medium rolls on the rotary disk. The rotary disk has first and second surfaces where the lottery medium stops after rolling at time when the rotary disk stops rotating. When viewed from above, the first surface has an annular shape, and the second surface is disposed on an inner side of the annular shape. The first and second surfaces have different configurations such that the first surface applies a first force to the lottery medium during the rolling, the first force being different from a second force that the second surface applies to the lottery medium during the rolling.

### BACKGROUND

### Technical Field

The present invention relates to a lottery device and a game machine.

### Description of Related Art

Conventionally, a lottery device is known in which a lottery is performed by rolling a lottery medium such as a ball on a surface of an inverted truncated cone (see, for example, Patent Document 1).

### Patent Documents

Patent Document 1: Japanese Patent Application Laid-Open No. 2004-248690

### Technological Problem to be Solved By the Invention

The conventional lottery device disclosed in Patent Document 1 ejects the lottery medium at a predetermined angle relative to the peripheral edge of a fixed, reverse-truncated cone-shaped plate surface such that the lottery medium rolls along the surface during the lottery process. Such conventional lottery devices are not originally intended to rotate an inverted truncated cone-shaped board, and therefore do not take into account the situation that the centrifugal force exerted on the lottery media by the rotation of the board presses the lottery media against the peripheral edge of the board, preventing the lottery media from rolling. Furthermore, if the lottery medium adheres to the surface of the board, the lottery medium will no longer roll on the surface of the board, which will shorten the time the lottery medium rolls on the surface during the lottery process, which may affect the player's sense of expectation for the lottery and their amusement in the lottery game.

### SUMMARY

One or more embodiments of the present invention provide a lottery device and a game machine that can vary, with a simple configuration, the movement of the lottery medium on the rotary disk and extend the time the lottery medium rolls on the rotary disk.

The lottery according to one aspect of the present invention comprises a lottery medium that includes at least one lottery surface on which the lottery content is displayed, a rotary disk on which the lottery medium is placed, and a rotary driver that rotates the rotary disk such that the lottery medium rolls on the rotary disk, the rotary disk having a first surface and a second surface where the lottery medium stops after rolling at a time when the rotary disk stops rotating, when viewed from above, the first surface has an annular shape, and the second surface is disposed on an inner side of the annular shape of the first surface, and the first surface and the second surface have different configurations such that the first surface applies a first force to the lottery medium during the rolling, the first force being different from a second force that the second surface applies to the lottery medium during the rolling.

By adopting such a configuration, it is possible to vary, with a simple configuration, the movement of the lottery medium on the rotary disk and extend the time the lottery medium rolls on the rotary disk.

In the lottery device according to one aspect of the present invention, the first force applied by the first surface is greater than the second force applied by the second surface.

By adopting such a configuration, when the first surface and the second surface are rotating, the rolling time of the lottery medium on the first surface can be made longer than the rolling time on the second surface.

In the lottery device according to one aspect of the present invention, the first surface may have at least one of following characteristics: including a concave part; including a convex part; and being made of a material with high friction.

By adopting such a configuration, the frictional force that the first surface applies on the lottery medium can be improved compared to a surface portion that does not have any concave or convex portions or a surface portion that is made of a material with low friction.

In the lottery device according to one aspect of the present invention, the first surface may have an inverted truncated cone shape.

By adopting such a configuration, the lottery medium can roll inward toward the first surface under its own weight using a simple structure.

In the lottery device according to one aspect of the present invention, the second surface may have an annular connection part connected to the first surface, and a circular center part disposed on an inner side of the annular connection part, the connection part may have an inverted truncated cone shape, and the circular center part may have a flat, spherical, or conical surface.

By adopting such a configuration, it is possible to easily realize the lottery media gathering toward the center part side by means of their own weight.

In the lottery device according to one aspect of the present invention, the rotary disk may further have a protrusion disposed in the circular center part.

By adopting such a configuration, the lottery media are less likely to accumulate toward the center, and the lottery media are less likely to become stacked on each other.

In the lottery device according to one aspect of the present invention, when viewed from a side, the annular connection part may have a degree of inclination that is same as or smaller than a degree of inclination of the first surface.

By adopting such a configuration, and by using a simple configuration, it is possible to make the effect on the rolling of the lottery medium caused by the weight of the lottery medium on the second surface equal to or less than the effect on the rolling of the lottery medium caused by the weight of the lottery medium on the first surface, thereby making it possible to alter the movement of the lottery medium.

In the lottery device according to one aspect of the present invention, the lottery medium may have a plurality of lottery surfaces on which lottery contents are respectively displayed, and a plurality of curved surfaces disposed around the lottery surfaces, and the curved surfaces may be interconnected and uniformly distributed on a surface of a single sphere.

By adopting such a configuration, the rolling time of the lottery medium can be extended compared to a lottery medium in which a plurality of curved surfaces are not uniformly distributed on the surface of the single sphere.

In the lottery device according to one aspect of the present invention, each of the lottery surfaces may be a flat surface or a spherical surface having a curvature smaller than a curvature of the single sphere.

By adopting such a configuration, it is possible to reduce the effect of the lottery surface on the rolling of the lottery medium.

The game machine according to one aspect of the present invention comprising: a game unit that executes a first game and a second game; the aforementioned lottery device that executes a lottery game related to the first game and the second game; and a controller that causes the game unit to start the first game based on a player's operation and obtains a game result of the first game, causes the lottery device to start the lottery game based on the game result and obtains a lottery result, and causes the game unit to start the second game based on the lottery result.

By adopting such a configuration, it is possible to enhance players'sense of expectation about the lottery and their interested in the lottery game by extending the lottery time by using a simple configuration.

One or more embodiments of the present invention provide a lottery device and a game machine that can increase players'sense of expectation for the lottery and the amusement in the lottery game by using a simple configuration to vary the movement of the lottery medium on the rotary disk and extend the time the lottery medium rolls on the rotary disk.

### BRIEF DESCRIPTION OF THE DRAWINGS

FIG. 1 is a perspective view showing the configuration of a game machine according to one or more embodiments of the present invention.

FIG. 2 is a schematic diagram showing the operational state of the game machine according to one or more embodiments.

FIG. 3 is a perspective view showing details of the game unit of the game machine according to one or more embodiments.

FIG. 4 is a diagram showing the configuration of the medal game unit and the first game unit of the game apparatus according to one or more embodiments.

FIG. 5 is a diagram showing the display content of the display device of the first game unit of the game machine according to one or more embodiments.

FIG. 6 is a diagram showing the other display content of the display device of the first game unit of the game machine according to one or more embodiments.

FIG. 7 is a diagram showing the display content of the display device of the second game unit of the game machine according to one or more embodiments.

FIG. 8 is a diagram showing the configuration of the dice selection part of the game machine according to one or more embodiments.

FIG. 9 is a perspective view showing the configuration of the dice of the game machine according to one or more embodiments.

FIG. 10 is a front side view showing the configuration of a game machine according to one or more embodiments of the present invention.

FIG. 11 is a diagram showing the configuration of the rotary disk of the dice selection part of the game machine according to one or more embodiments.

FIG. 12 is a perspective diagram showing the configuration of the rotary disk of the dice selection part of the game machine according to one or more embodiments.

FIG. 13 is a diagram showing a modified example of the center part of the rotary disk in the dice selection part of the game machine according to one or more embodiments.

FIG. 14 is a diagram showing the effect of a modified example of the center part of the rotary disk in the dice selection part of the game machine according to one or more embodiments.

FIG. 15 is a diagram showing another modified example of the center part of the rotary disk in the dice selection part of the game machine according to one or more embodiments.

FIG. 16 is a diagram showing the effect of another modified example of the center part of the rotary disk in the dice selection part of the game machine according to one or more embodiments.

FIG. 17 is a flowchart for explaining the control of a game by the controller of the game machine according to one or more embodiments.

### DETAILED DESCRIPTION OF EMBODIMENTS

Hereinafter, embodiments will be described with reference to the drawings. Unless otherwise specified, the positional relationships such as up, down, left, and right on the drawings shall be based on the positional relationships shown on the drawings. Furthermore, the dimensional ratios of the drawings are not limited to those shown in the drawings. Additionally, the following embodiments are merely examples for explaining the present invention, and are not intended to limit the present invention to these embodiments only. Furthermore, the present invention can be modified in various ways without departing from the idea of the invention.

### Overview of Game Machine 1

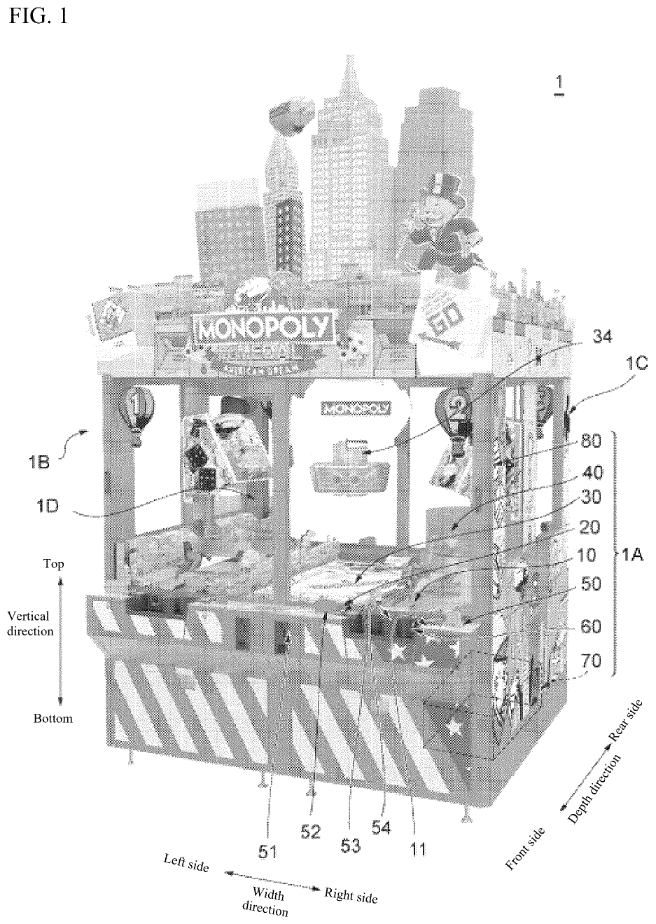

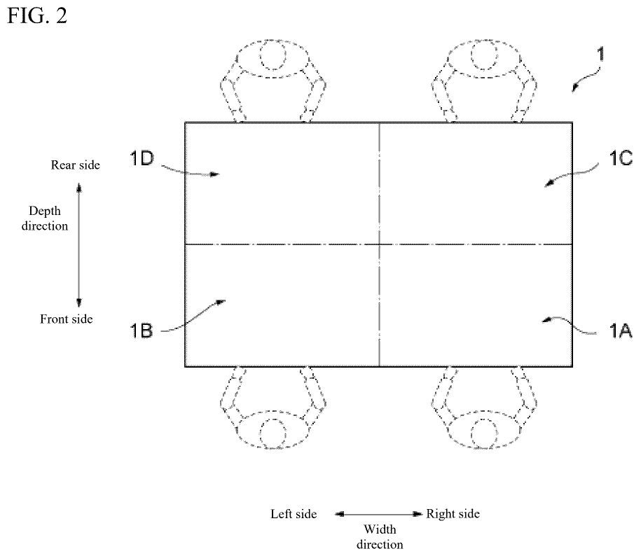

First, with reference to FIGS. 1 to 3, we will explain the general configuration of the game machine 1 according to one or more embodiments and the game performed by the game machine 1. FIG. 1 is a perspective view showing the configuration of the game machine 1. FIG. 2 is a schematic diagram showing the operational state of the game machine.

The game machine 1 according to one or more embodiments is an example of a game machine that allows a plurality of players to play their own games simultaneously. Here, the games according to one or more embodiments include, for example, a medal game, a first Monopoly game which is an example of a first game, a dice lottery game, and a second Monopoly game which is an example of a second game, all of which are played in each game unit described below. Among these, medal games and dice lottery games are, for example, games to be physically played, while the first Monopoly game and the second Monopoly game are, for example, digital games displayed on a display device. Additionally, the medal game is a lottery game related to the first Monopoly game. On the other hand, the dice lottery game is a lottery game related to the first Monopoly game and the second Monopoly game.

Furthermore, the game machine 1 is a game machine for four players. Specifically, the game machine 1 includes game machines 1A to 1D as shown in FIG. 2. Game machines 1A to 1D each have the same configuration. Therefore, by changing the number of game machines constituting the game machine 1, the number of players that can use the game machine 1 can be changed to a that number other than one or four. In the following description, the configuration of the game machine 1A will be mainly described.

### Details of Game Machine 1A

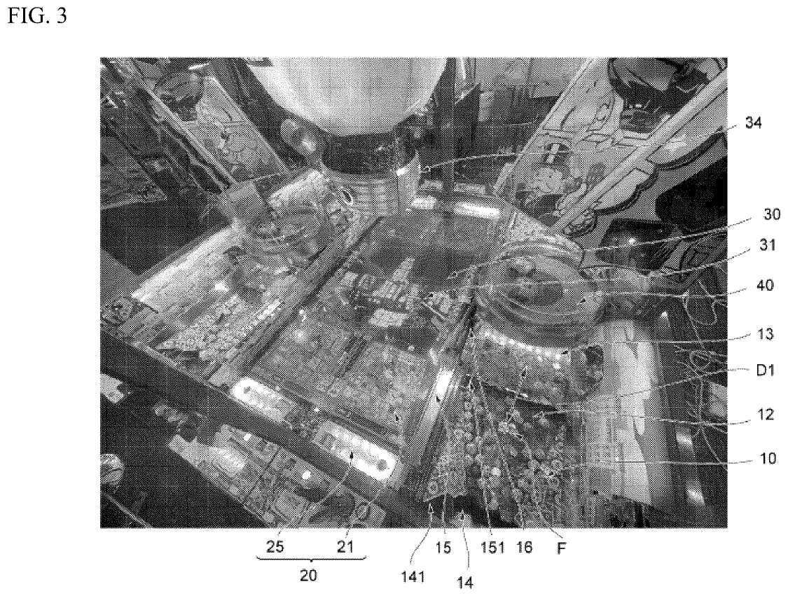

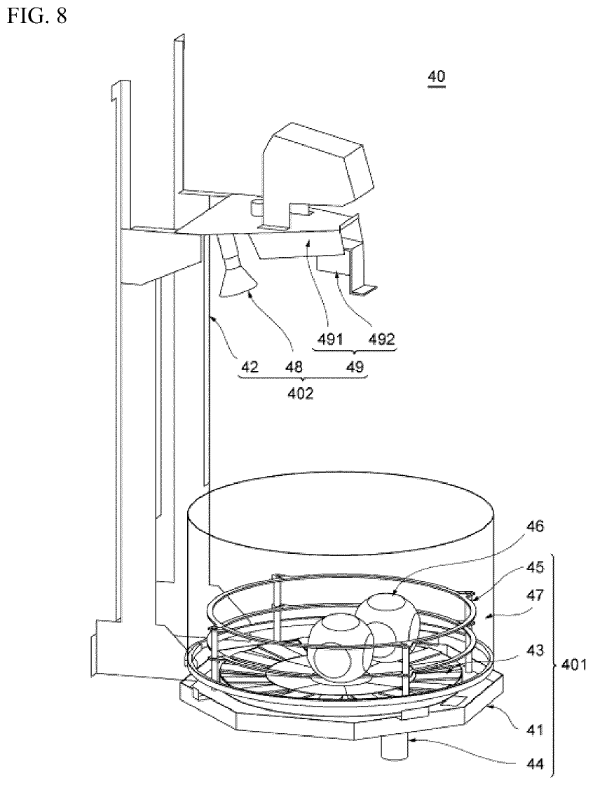

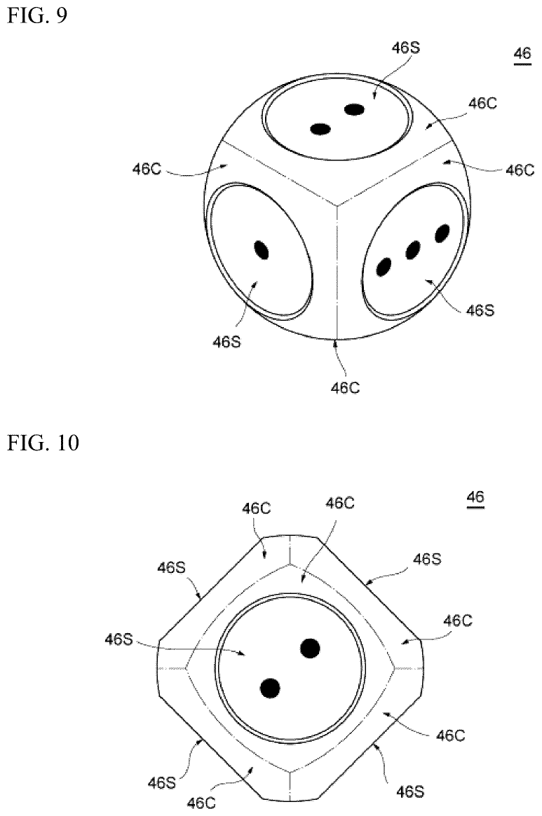

Next, with reference to FIGS. 1 through 16, the detailed configuration of the game machine 1A according to one or more embodiments will be described. FIGS. 3 to 7 are diagrams showing the details of the game unit of the game machine 1. FIGS. 8, 11, and 12 are diagrams for explaining the configuration of the dice lottery unit 40. FIGS. 9 and 10 are diagrams showing the configuration of a dice (an example of a lottery medium) 46. FIGS. 13 to 16 are diagrams showing modified examples of the second surface 432 of the dice lottery unit 40.

As shown in FIGS. 1 to 3, the game machine 1A includes: a medal game unit 10 for playing a medal game; a first game unit 20 for playing a first Monopoly game; a second game unit 30 for playing a second Monopoly game; a dice lottery unit 40 for playing a dice lottery game, an operation device 50 for receiving operations from a player; a dispenser 60 that pays out play result media to a player such as prize exchange tickets in a number corresponding to the result of the lottery game; a controller 70 that comprises a central processing unit (CPU) and executes a lottery game by controlling the operation of the medal game unit 10, the first game unit 20, the second game unit 30, the dice lottery unit 40, the operation device 50, and the dispenser 60; and a housing 80 that supports or houses the above-mentioned components.

### Medal Game Unit 10

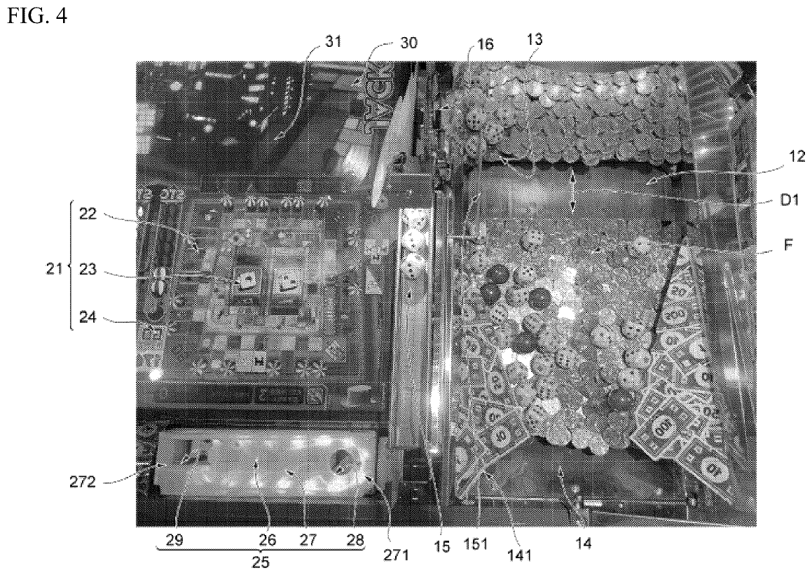

First, the configuration of the medal game unit 10 will be described with reference to FIGS. 3 and 4. The medal game unit 10 is an example of a configuration for playing a medal game. Here, the medal game includes a medal insertion game, a medal pusher game, a lottery medium pusher game, and a medium lottery game that is carried out via a lottery medium. The lottery medium may include, for example, a ball with a built-in dice, a dice, and the like.

The medal game unit 10 may comprise a central processing unit (CPU) and has, as shown in FIGS. 3 and 4: a medal insertion part 11 (see FIG. 1) that inserts medals into the medal game area F based on a player's operation; a placement surface 12 for placing medals and lottery media; a pusher table 13 for moving the medals and lottery media placed on the placement surface 12; a dropping part 14 into which the medals and lottery media placed on the placement surface 12 can fall; a lottery media supplier 15 for supplying lottery media to the top surface of the pusher table 13; and a medal supplier 16 for supplying medals to the top surface of the pusher table 13.

Here, the medal game area F is an area comprised of the placement surface 12 and the upper surface of the pusher table 13, as shown in FIG. 3. The medal game area F has a rectangular shape when viewed from the front. Additionally, the shorter side of the medal game area F is aligned with the width direction of the game machine 1 (see FIG. 1), and the longer side is aligned with the depth direction of the game machine 1 (see FIG. 1).

### Medal Insertion Part 11

The medal insertion part 11 is configured to be used in the medal insertion game. As shown in FIG. 1, the medal insertion part 11 is configured such that the player can adjust the direction of the medal inserted into the medal game area F (see FIGS. 3 and 4) via the medal insertion part 11 by operating an adjustment handle 52 of the operation device 50, which will be described later. In this way, the player can insert medals into the position in the medal game area F as desired by the player. Furthermore, medals inserted into the game area F through the medal insertion part 11 move so as to fall onto the placement surface 12 via the pusher table 13.

### Placement Surface 12

The placement surface 12 is configured to be used for a medal insertion game, a medal pusher game, and a lottery medium pusher game. The placement surface 12 has a rectangular shape when viewed in plan view. As shown in FIG. 3, the placement surface 12 is provided such that its longitudinal direction is aligned with the longitudinal direction of the medal game area. Furthermore, the placement surface 12 can place medals inserted through the medal insertion part 11, as well as medals and lottery media dropped from the pusher table 13.

### Pusher Table 13

The pusher table 13 is configured to be used for the medal pusher game and the lottery medium pusher game. As shown in FIG. 3, the pusher table 13 is provided above the placement surface 12 and at the rear end of the placement surface 12 in the longitudinal direction. The pusher table 13 can be moved horizontally back and forth via the controller 70 within a predetermined range in the first direction D1 shown in FIG. 3. The first direction D1 is a direction along the longitudinal direction of the placement surface 12.

### Dropping Part 14

The dropping part 14 is configured to be used in the medal insertion game. The dropping part 14 is provided on the front side of the placement surface 12 in the longitudinal direction of the placement surface 12. As shown in FIG. 4, the dropping part 14 has a drop opening 141 and a medium detection sensor and a medal number detection sensor (not illustrated) provided below the drop opening 141.

The drop opening 141 can cause medals and lottery media, which are positioned at the front edge of the placement surface 12 and pushed by the pusher table 13, to fall from the placement surface 12.

The media detection sensor can detect media lottery information, including whether lottery media has fallen to the bottom of the dropping part 14 and the dice roll result indicated by the lottery media that have fallen to the bottom of the dropping part 14. Furthermore, when the medium detection sensor detects medium lottery information, it transmits the medium lottery information to the controller 70. Additionally, the controller 70 can start the first Monopoly game by the first game unit 20 based on the medium lottery information.

Furthermore, the medals that have fallen into the dropping part 14 are transported to and stored in a medal storage part (not illustrated) of the medal supplier 16 via a medal transport mechanism (not illustrated). In contrast, the lottery medium that has dropped into the dropping part 14 is transported to the lottery medium supplier 15 via a lottery medium transport structure (not illustrated).

### Lottery Media Supplier 15

The lottery medium supplier 15 is configured to supply lottery media for a medal game to the medal game area F. The lottery medium supplier 15 includes, for example, a transport lift that transports the lottery medium (not illustrated), and a guide part 151 (see FIGS. 3 and 4) that guides the transported lottery medium to the medal game area F by the transport lift. The transport lift is configured, for example, to transport the lottery medium to the upper surface of the pusher table 13 every time the lottery medium is transported to the lottery medium supplier 15 by the lottery medium transport configuration.

### Medal Supplier 16

The lottery medium supplier 16 is configured to supply lottery media for a medal game to the medal game area F. The medal supplier 16 has, for example, a medal storage part that stores medals and a medal transport part (not illustrated). For example, when the number of medals in the medal game area F is below a certain number, the medal transport part is configured to take out a predetermined number of medals from the medal storage part and supply them to the medal game area F based on a request from the controller 70 to replenish medals in the medal game area F.

### First Game Unit 20

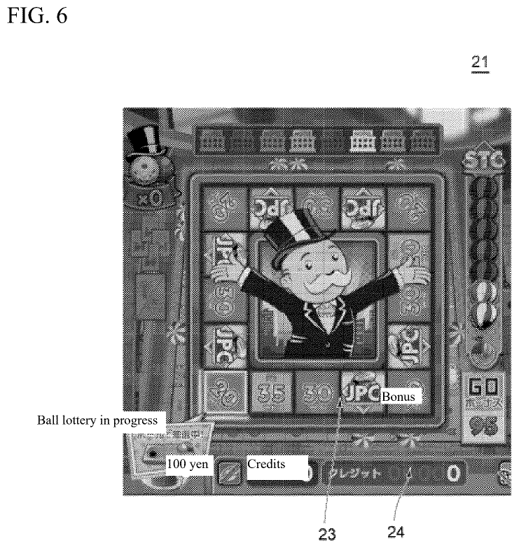

Next, the configuration of the first game unit 20 will be explained with reference to FIGS. 3 and 6. The first game unit 20 is an example of a game unit for playing the first Monopoly game. The first game unit 20 may comprise a central processing unit (CPU) and is configured to conduct the first Monopoly game based on control from the controller 70.

Specifically, when the controller 70 receives medium lottery information transmitted from the medium detection sensor, it transmits first game start information to the first game unit 20. Then, the first game unit 20 starts and progresses the first Monopoly game based on the first game start information.

Here, the first game start information includes: for example, start information for starting the first Monopoly game; and die roll result information indicated on the lottery medium dropped to the bottom of the dropping part 14 detected by the medium detection sensor and received by the control section 70.

As shown in FIGS. 3 and 4, the first game unit 20 includes a display device 21 and a physical lottery device 25. The display device 21 is configured to display the details of the first Monopoly game to the player. The physical lottery device 25 is configured to determine the timing of stopping the rotation of the slot for the first dice slot lottery displayed by the display device 21 described below.

As shown in FIG. 4, the display device 21 includes, for example, a frame-shaped first display area 22 that displays the first Monopoly game, a second display area 23 located inside the first display area 22 that displays information related to the lottery or the like, and a third display area 24 located outside the first display area 22 that displays the game fee paid by the player and game result information of the first Monopoly game or the like.

For example, as shown in FIG. 4, the first display area 22 displays a first playing piece in the first Monopoly game and a first board onto which the first playing piece moves. The first board displays information related to the first Monopoly game, such as property spaces, public utility spaces, railroad spaces, Chance space, and Community Chest space, jail space, and buildings constructed by players. In addition, the first playing piece moves a number of steps on the first board corresponding to the total for the die roll result displayed in the second display area 23 described later, based on the total number of points displayed in the two dice slots.

The second display area 23 can, for example, a display area including two die slot screens as shown in FIG. 4. Of the two dice slot screens, the first dice slot screen displays the results of a physical dice lottery. Here, the dice lottery result of the first dice slot is the dice roll result displayed on the first dice slot screen at the timing when the rotation of the first dice slot stops as determined by the physical lottery device 25. The second dice slot screen displays the results of a digital dice lottery. The lottery on the second dice slot screen starts when the first game start information is received by the first game unit 20.

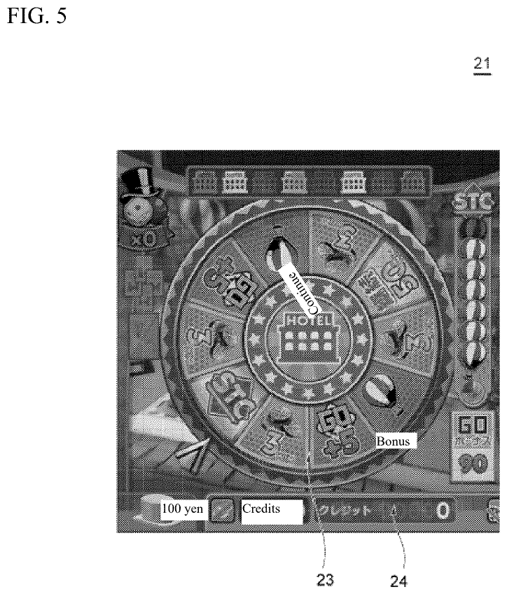

The second display area 23 may display other lottery games in addition to the two dice slot screens shown in FIG. 4. For example, when the first playing piece of the player lands on the “Chance” space, the second display area 23 can display the first roulette lottery shown in FIG. 5. Additionally, if the result of the first roulette lottery is “Challenge,” the second display area 23 can further display the second roulette lottery shown in FIG. 6.

Here, the first roulette lottery shown in FIG. 5 has a feature that, for example, the higher the price of the land on which the hotel built by the player is located, the higher the possibility of the number of “winning spaces” increasing. The second roulette lottery has a feature that, for example, the greater the number of hotels built by the player is located, the higher the possibility of the number of “winning spaces” becomes. The “winning spaces” are accumulated in the “Monopoly Challenge” shown in the third display area 24 described below. When the number of “winning spaces” accumulated in the “Monopoly Challenge” reaches a predetermined amount (e.g., 7), the controller 70 starts the second Monopoly game using the second game unit 30. Meanwhile, if the number of “winning spaces” accumulated in the “Monopoly Challenge” lottery is equal to or less than a predetermined number, and the “Big Monopoly” is won in the second roulette lottery, the controller 70 also starts the second Monopoly game using the second game unit 30.

The third display area 24, for example as shown in FIGS. 4 to 6, is located on the outer periphery of the second display area 23, and displays: information on the game fees paid by the player and the credits acquired by the player in the first Monopoly game; “Monopoly Challenge” information for storing “winning spaces” obtained by the player in the first roulette lottery and/or second roulette lottery; card information obtained by the player in the first Monopoly game; “GO Bonus” information; and information regarding the player's use of public utilities.

The physical lottery device 25 is configured to physically select the timing of stopping the rotation of the first dice slot using a ball. The physical lottery device 25, as shown in FIG. 4, comprises a lottery main body 26, a lottery surface 27 forming the upper surface of the lottery main body 26, and ball drop openings 28 and ball transport openings 29 provided at both ends of the lottery surface 27.

As shown in FIG. 4, the lottery surface 27 has a right end 271 and a left end 272. Additionally, the lottery surface 27 is inclined such that the right end 271 is lower than the left end 272. The ball drop opening 28 is provided at the right end 271, and the ball transport opening 29 is provided at the left end 272. With this configuration, the balls coming out of the ball transport opening 29 can roll and fall along the lottery surface 27 toward the ball drop opening 28 by means of their own weight.

The lottery main body 26 has a storage part (not illustrated) for storing balls, a transport part for removing the balls from the storage part and transporting them to the ball transport opening 29, and a calculation part for calculating the time it takes for the balls to drop into the ball drop opening 28 after leaving the ball transport opening 29. With this lottery main body 26, it is possible to easily calculate the time from when the ball leaves the ball transport opening 29 until it falls into the ball drop opening 28, that is, the timing at which the rotation of the first dice slot stops.

Furthermore, the transport part can transport the ball to the ball drop opening 28 so as to change the state of the ball, such as the speed and direction, when the ball leaves the ball transport opening 29, for example. In this way, it is possible to change the timing at which the rotation of the first dice slot stops.

### Second Game Unit 30

Next, the configuration of the first game unit 20 will be explained with reference to FIGS. 1, 3, and 7. The second game unit 30 is an example of a game unit for playing the second Monopoly game. Furthermore, the second game unit 30 is shared by four players, and is a game unit that each player can use in a predetermined order. The second game unit 30 may comprise a central processing unit (CPU) and is configured to conduct the second Monopoly game based on control from the controller 70.

Specifically, when the controller 70 receives information indicating that the “winning spaces” accumulated in the “Monopoly Challenge” during the first roulette lottery and/or second roulette lottery transmitted from the first game unit 20 have reached a predetermined number (e.g., 7), or when it receives information related to hitting “Big Monopoly” in the second roulette lottery, it sends second game start information to the second game unit 30 and the dice lottery unit 40. Then, the second game unit 30 and the dice lottery unit 40 start and progress the second Monopoly game based on the second game start information.

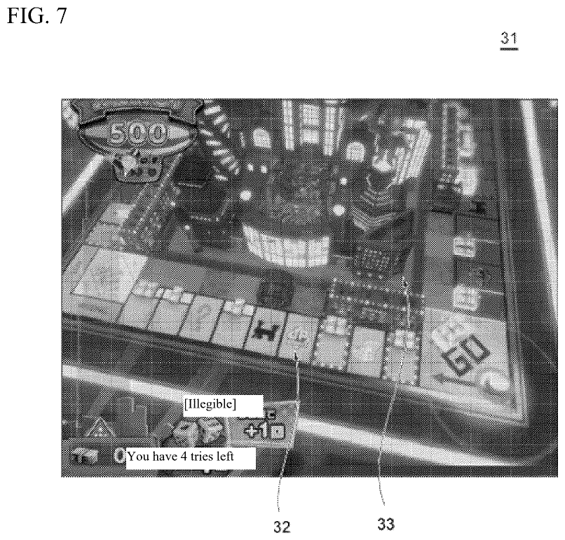

As shown in FIGS. 1 and 3, the second game unit 30 includes a display device 31 and a medal dispenser 34. The display device 31 displays the details of the second Monopoly game to the player. The display device 31 is configured to be shared by four players and is larger than the display device 21 of the first game unit 20. Furthermore, the display device 31 includes, for example, as shown in FIGS. 3 and 7, a first display area 32 in the form of a frame for displaying the second Monopoly game, and a second display area 33 located inside the first display area 32 for displaying information (e.g., buildings, townscapes, etc.) related to the board displayed inside of the first display area 32.

For example, as shown in FIGS. 3 and 7, the second display area 32 displays a second playing piece in the second Monopoly game and a second board onto which the second playing piece moves. The second board displays information related to the second Monopoly game, such as property spaces, points corresponding to each property space (not illustrated), and the jail space. Additionally, the second piece moves the corresponding number of steps on the second board based on the die roll result of the dice selection part 40 described below, specifically the total of the two dice rolls from the dice selection part 40.

The medal payout section 34 is configured to be shared by four players. When a player obtains a “jackpot” (described later) in the second Monopoly game, the medal dispenser 34 can move above the medal game area F of the medal game unit 10 used by the player and payout to the player a number of medals corresponding to the “jackpot.”

Here, the second Monopoly game ends, in principle, after the dice lottery unit 40 has performed a predetermined number of rolls (for example, five rolls), or when the second playing piece lands on the “Jail” space shown on the second board even though the dice lottery unit 40 has not performed the predetermined number of rolls. Additionally, if a player accumulates a predetermined number of points (e.g., 300 points) before the second Monopoly game ends, that player can win the “jackpot.”

### Dice Lottery Unit 40

Next, the configuration of the dice lottery unit 40 and modified examples of the second surface 432 of the dice lottery unit 40, which will be described below, will be described with reference to FIGS. 8 and 11 to 16. The dice lottery unit 40 is an example of a lottery device for playing a dice lottery game. The dice lottery unit 40 is a lottery device that is shared by two players and can be used by each player in a predetermined order. The dice lottery unit 40 may comprise a central processing unit (CPU) and is configured to conduct a dice lottery game based on controls performed by the controller 70. Specifically, when the dice lottery unit 40 receives the second game start information from the controller 70, it starts the dice lottery game.

Here, the dice lottery game is a physical lottery that is conducted using two dice 46. The dice 46 used in the dice lottery game is an example of a lottery medium having a lottery surface on which lottery contents for the lottery are displayed. Specifically, as shown in FIGS. 9 and 10, the die 46 has six lottery faces 46S and curved faces 46C provided around each of the six lottery faces 46S. Each of the six lottery surfaces 46S is a flat surface or a spherical surface whose curvature is smaller than that of a single sphere on which six curved surfaces 46C (described below) are located. The die roll results that will be rolled, which is an example of different lottery contents, are printed on each of the six lottery faces 46S. Each lottery surface 46S may be a display part that digitally displays different lottery contents. As shown in FIG. 9, the six curved surfaces 46C are interconnected and uniformly distributed on the surface of one sphere. The curved surface 46C having such characteristics can extend the rolling time of the dice 46 on the rotary disk 43 described below.

In the above description, the die 46 is described as having six lottery faces 46S and six curved faces 46C that are interconnected and uniformly distributed on the surface of a single sphere, but this is not limited to this. The six curved surfaces 46C of the 6-sided die 46 need not be interconnected and need not be uniformly distributed on the surface of a single sphere. Furthermore, the die 46 may have only one lottery face 46S, or may have a number of lottery faces 46S other than six. Furthermore, the lottery content indicated by the lottery face 46S may be other than the roll result, such as numerical displays, patterns, and alphabetic characters.

As shown in FIG. 8, the dice lottery unit 40 includes a lottery configuration 401 related to the dice lottery and an identification configuration 402 related to the identification of the dice lottery result. As shown in FIG. 8, the lottery configuration 401 comprises: a first base part 41, a rotary disk 43 rotatably supported by the first base part 41 and on which dice 46 are placed; a rotary driver 44 configured to rotate the rotary disk 43 and cause the dice 46 placed on the rotary disk 43 to roll on the rotary disk 43; a guide part 45 provided around the rotary disk 43; and a protective part 47 provided on the outer periphery of the guide part 45 to prevent the dice 46 from jumping out of the guide part 45 due to the rotation of the rotary disk 43. As shown in FIG. 8, the identification configuration 402 includes: a second base part 42; an illumination portion 48 supported by the second base part 42; and a dice recognition part 49 supported by the second base part 42.

### Rotary Disk 43

The rotary disk 43 is configured to support the two dice 46 while transmitting the rotational force from the rotary driver 44 to the two dice 46. In other words, each of the two dice 46 can roll on the rotary disk 43 by means of the frictional force between the dice 46 and the rotary disk 43. As shown in FIG. 8, the entire rotary disk 43 has an inverted truncated cone shape. Here, the expression “inverted truncated cone shape” includes shapes with spherical side surfaces. The same applies to the explanation below.

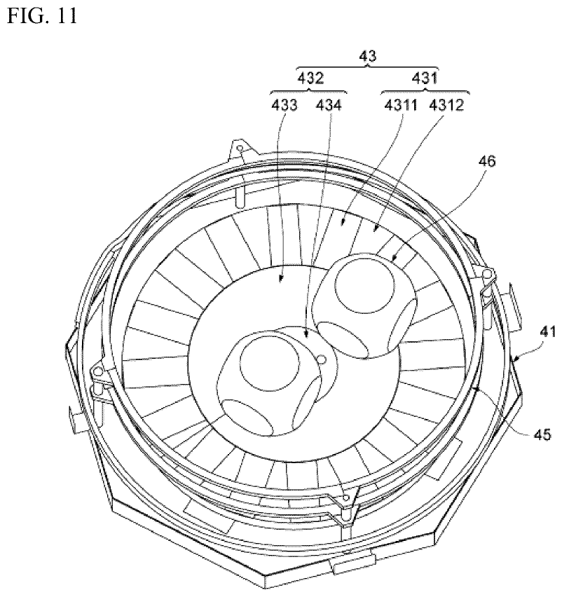

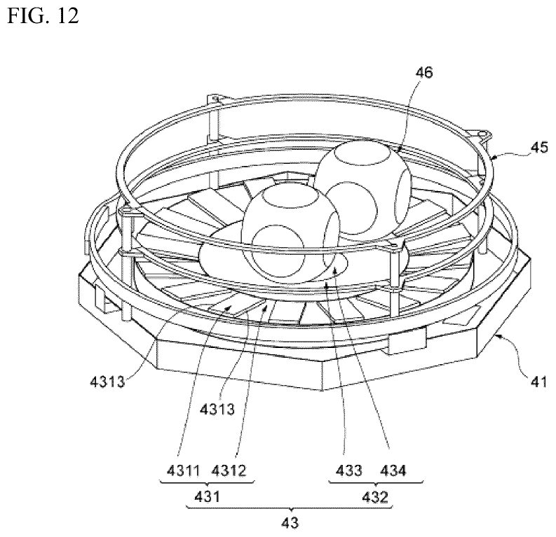

The configuration of the rotary disk 43 will now be described in more detail. As shown in FIGS. 11 and 12, the rotary disk 43 has a first surface 431 and a second surface 432 on which the two dice 46 can roll and stop after the rotary disk 43 stops rotating.

When the rotary disk 43 is viewed from above, as shown in FIG. 11, the first surface 431 has an annular shape, and the second surface 432 is a circular portion located on the inner peripheral side of the first surface 431. The first surface 431 has an inverted truncated cone shape. The second surface 432, as shown in FIG. 12, has an inverted truncated cone shape with no opening in its center.

In this way, due to the inverted truncated cone shaped portions of the first surface 431 and the second surface 432, when the dice 46 are pressed against the guide part 45 at the outer periphery of the rotary disk 43 by the centrifugal force caused by the rotation of the rotary disk 43, the dice 46 can roll inside the rotary disk 43 by means of their own weight, whereby it is possible to prevent the dice 46 from being pressed against the guide part 45 by the centrifugal force and becoming unable to roll.

Furthermore, the first surface 431 and the second surface 432 have different surface configurations such that the force applied to the rolling dice 46 by the first surface 431 is different from the force applied to the rolling dice 46 by the second surface 432. For example, the first surface 431 is configured such that the force applied to the two dice 46 rolling on the first surface 431 is greater than the force applied to the two dice 46 rolling on the second surface 432.

Specifically, the first surface 431 has a plurality of concave parts 4311 provided on its surface, as shown in, for example, FIGS. 11 and 12. The concave parts 4311 have a rectangular shape when viewed in plan view. As shown in FIG. 11, the plurality of concave parts 4311 are provided at equal intervals around the circumference of the first surface 431, as shown in FIG. 11. In this way, recesses 4312 are formed between the two concave parts 4311.

In contrast to the first surface 431 having such characteristics, the second surface 432 has, for example, as shown in FIGS. 11 and 12, a smooth surface without any concave parts or convex parts. Furthermore, the second surface 432 is not made of a material with higher friction than the first surface 431.

Thus, by using the first surface 431 and second surface 432 having the above configuration, the frictional force applied by the first surface 431 on the dice 46 can be made greater than the frictional force exerted by the second surface 432 on the dice 46. Therefore, when the rotary disk 43 rotates, the driving force that the first surface 431 applies to the dice 46 to roll the dice 46 is greater than the driving force that the second surface 432 applies to the dice 46.

Specifically, as shown in FIG. 12, each of the concave parts 4311 has ridge lines 4313 on both sides. Such ridge lines 4313 of the concave parts 4311 allow the ridge lines 4313 of the concave parts 4311 to come into contact with the dice 46 when the rotary disk 43 rotates. Furthermore, such contact allows the ridge lines 4313 rotating together with the rotary disk 43 to push against the dice 46, providing the dice 46 with the force to roll. As a result, when the rotary disk 43 rotates, the rolling time of the dice 46 on the rotary disk 43 can be extended.

Here, the first surface 431 has been described as having a plurality of convex parts 4311, but the present invention is not limited to this. The first surface 431 may have only one convex part 4311, or instead of the convex part 4311, may have one or a plurality of concave parts formed to be recessed from the surface, and may be made of a material with high friction. Furthermore, the shape of the convex parts 4311 when viewed in plan view may be a non-rectangular shape, such as circular, polygonal, or irregular. Additionally, the first surface 431 may have at least two of the following characteristics: including a recess; including a convex part; and being made of a material with high friction.

Furthermore, although the second surface 432 has been described as having a smooth surface without convex parts or concave parts, this description is not intended to be limiting. The second surface 432 may have any configuration that applies a smaller force to the two rolling dice 46 than the first surface 431. For example, in a case where a plurality of concave parts and convex parts are formed on the first surface 431, the second surface 432 may have concave parts and convex parts that are shallower than the concave parts and convex parts on the first surface 431, or may have a smaller number of concave parts and convex parts than the number of concave parts and convex parts on the first surface 431. Furthermore, when the first surface 431 is composed of a material with high friction, the second surface 432 may be composed of a material with lower friction than the first surface 431.

Additionally, in the explanation above, the first surface 431 has an annular shape when viewed in plan view, and the second surface 432 has a circular shape when viewed in plan view, but it is not limited to this. The first surface 431 and the second surface 432 may be configured such that the first surface 431 is positioned closer to the periphery of the rotary disk 43 than the second surface 432, and the first surface 431 applies a greater force to the two rolling dice 46 than the second surface 432. For example, the shape of the first surface 431 when viewed in plan view may be a shape other than annular, and the shape of the second surface 432 when viewed in plan view may be a shape other than circular. Specifically, the shape of the first surface 431, when viewed in plan view, may be configured such that it is one or a plurality of components arranged circumferentially on the peripheral edge side of the rotary disk 43 are not connected to each other. In this case, the shape of the second surface 432 when viewed in plan view may have both a portion located inside each component of the first surface 431 and a portion extending toward the peripheral edge of the rotary disk 43 through the unconnected portions of each component of the first surface 431. Furthermore, the rotary disk 43 may have other surface parts in addition to the first surface 431 and the second surface 432.

The configuration of the second surface 432 will now be described in more detail. As shown in FIGS. 11 and 12, the second surface 432 has a connection part 433 that is connected to the first surface 431 and has an annular shape when viewed in plan view, and a center part 434 that is located on the inner side of the connection part 433 and has a circular shape when viewed in plan view.

As shown in FIG. 12, the entire connection part 433 has an inverted truncated cone shape. When the rotary disk 43 is viewed from the side, the inclination of the connection part 433 is the same as the inclination of the first surface 431. Moreover, the inclination of the connection part 433 may be smaller than the inclination of the first surface 431. With the first surface 431 and the connection part 433 having such an inclination, the effect of the weight of the die 46 on the rolling of the die 46 at the connection part 433 can be made equal to or less than the effect of the weight of the die 46 on the rolling of the die 46 at the first surface 431, thereby making it possible to change the movement of the connection part 433.

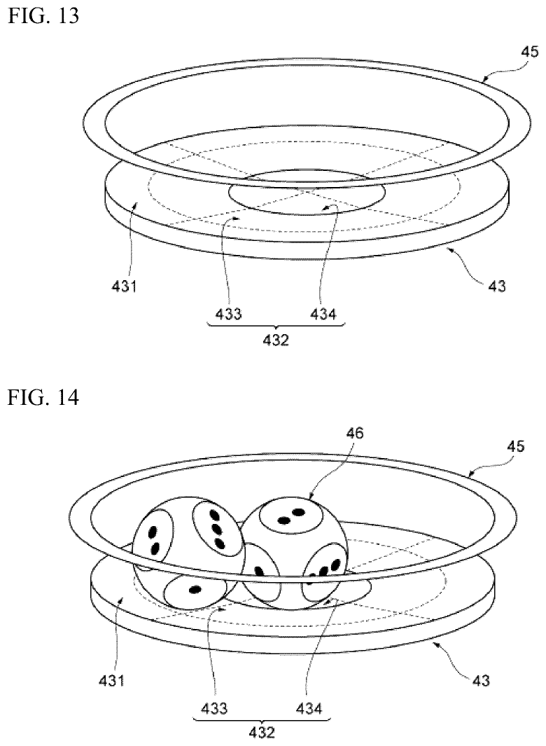

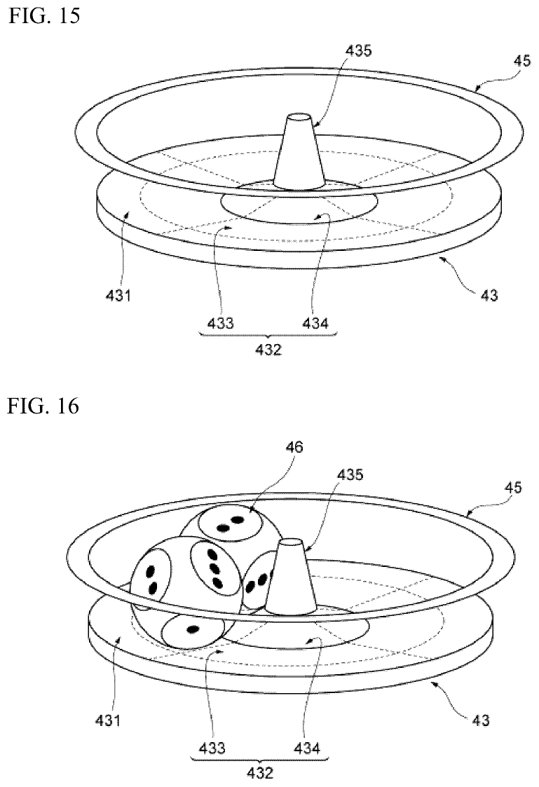

As shown in FIGS. 11 and 12, the center part 434 has a flat shape In contrast, the shape of the center part 434 may be a shape other than flat. For example, the shape of the center part 434 may be a conical surface (or a spherical surface) that protrudes downward relative to the connection part 433, as shown in FIG. 13. By using such a center part 434, the two dice 46 will be prone to accumulate at the center part 434 side, as shown in FIG. 14. As a result, the two dice 46 will be prone to stacking on each other. In this way, the two dice 46 are less likely to remain leaning against the guide part 45. Furthermore, protrusions 435 may be provided on the center part 434 as shown in FIG. 15. By using such protrusions 435, the two dice 46 will be less prone accumulate at the center part 434 side, as shown in FIG. 16. As a result, the two dice 46 will be less prone to stacking on each other. Furthermore, the shape of the center part 434 may be a conical surface or a spherical surface that protrudes upward relative to the connection part 433.

### Rotary Driver 44

The rotary driver 44 is a component for driving the rotation of the rotary disk 43. As shown in FIG. 8, the rotary driver 44 is attached to the rear surface of the first base part 41. The rotary driver 44 can output a rotation force, for example, when the dice lottery unit 40 receives second game start information from the controller 70, and stop outputting the rotation force after a predetermined time has elapsed. With such a rotary driver 44, the rotary disk 43 can be stopped after a predetermined time from when it rotates.

### Guide Part 45

The guide part 45 is configured to guide the rolling direction of the dice 46. The guide part 45 has a circular frame structure, for example, as shown in FIG. 8. The guide part 45 is provided so as to be able to come into contact with the dice 46 when the dice 46 rotates on the periphery of the rotary disk 43. In this way, the guide part 45 can guide the rolling direction of the dice 46 such that the dice 46 do not jump out of the rotary disk 43.

### Protective Part 47

The protective part 47 is configured to prevent the dice 46 from flying out of the guide part 45 due to the dice 46 bouncing off the rotary disk 43 while rolling. The protective part 47 has a circular frame structure formed higher than the guide part 45 as shown in FIG. 8. Additionally, the protective part 47 is made of a transparent material. In this way, the player can visually check the progress of the dice lottery game.

### Second Base Part 42

As shown in FIG. 8, the second base part 42 is attached to the peripheral edge of the first base part 41. The upper end of the second base part 42 supports the illumination part 48 and the dice recognition part 49 such that the illumination part 48 and the dice recognition part 49 are positioned above the rotary disk 43.

### Illumination Part 48

As shown in FIG. 8, the illumination part 48 is configured to illuminate the rotary disk 43. Such an illumination part 48 makes it easier for the player to see the dice lottery game, and also improves the appearance of the dice lottery game.

### Dice Recognition Part 49

The dice recognition part 49 is configured to recognize the lottery results of the dice lottery game, that is, the dice roll result from rolling each of the two dice 46 after they have stopped. As shown in FIG. 8, the dice recognition part 49 has an irradiation light source 491 that irradiates light onto the dice 46, and a dice recognition camera 492 that identifies the number of dots on the dice 46 irradiated by the irradiation light source 491.

The irradiation light source 491 emits, for example, infrared light. The dice recognition camera 492 captures images of the dice roll result from rolling the two dice 46 illuminated by infrared light, and transmits information on the total dice roll result corresponding to the two images to the controller 70. Then, based on the total dice roll result information, the controller 70 can move the second playing piece relating to the second Monopoly game to the second board by the number of steps corresponding to the total dice roll result.

The dice recognition part 49 is not limited to recognizing the dice roll result of the dice 46 in the above-described manner. The dice recognition part 49 may, for example, not employ the irradiation light source 491 and instead use visible light to identify the dice roll result of the dice 46. Additionally, the dice recognition part 49 may identify the dice roll result of the dice 46, for example, using an RFID method. Furthermore, the dice recognition part 49 may be configured to transmit recognition error information to the controller 70 when a recognition error occurs in the dice recognition part 49, for example, due to the two dice 46 being stacked on top of each other. Based on such recognition error information, the controller 70 can eliminate the stacking of the two dice 46 by re-spinning the rotary disk 43 or by spinning the rotary disk 43 at a slower speed than during the dice lottery.

### Operation Device 50

Next, the configuration of the operation device 50 will be explained with reference to FIG. 1. The operation device 50 is an example of a configuration for accepting operations by a player to play the game according to one or more embodiments. As shown in FIG. 1, the operation device 50 includes: a fee insertion slot 51 for accepting game fees from the player, an adjustment handle 52 for rotating the medal supplier 16; a medal insertion button 53 for inserting medals into the medal game area F via the medal insertion part 11; and an operation button 54 for accepting operations for the first Monopoly game, the second Monopoly game, and the dice lottery game.

The operation button 54 receives, for example, game operations by the player relating to each of the first and second Monopoly games, such as land purchase, lottery, and building construction, and lottery operations such as starting and stopping the dice lottery game.

### Control by the Controller 70

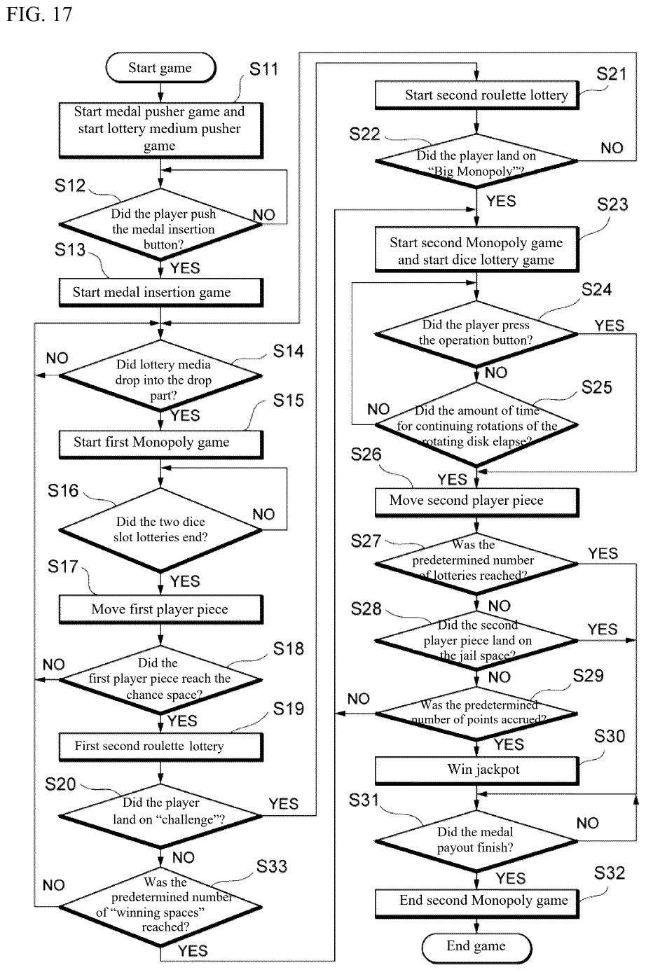

Next, with reference to FIG. 17, an example of control by the controller 70, that is, processing related to the game according to one or more embodiments that is performed by the controller 70 based on data and programs stored in memory, will be described. Additionally, depending on the settings, the controller 70 can perform processes relating to different games. FIG. 17 is a flowchart illustrating the control of the lottery game by the controller 70.

### Step S11

When a player inserts a predetermined game fee into the fee insertion slot 51, the controller 70 will start the game according to one or more embodiments. Additionally, once the game begins, the medal games (the medal pusher game and the lottery medium pusher game) will begin (Step S11).

### Steps S12, S13, S14, and S15

The controller 70 determines whether or not the player has pressed the medal insertion button 53 (step S12). When the player presses the medal insertion button 53 (“YES” in step S12), the controller 70 will start the medal insertion game (step S13). Next, the controller 70 determines whether or not the lottery medium placed on the placement surface 12 has fallen into the dropping part 14 (step S14). If the lottery medium placed on the placement surface 12 falls into the dropping part 14 (“YES” in step S14), the controller 70 will start the first Monopoly game (step S15).

### Step S16, S17, S18, and S19

After the first Monopoly game begins, a lottery using two dice slots will be started. Then, the controller 70 will determine whether the lottery using the two dice slots has ended (step S16). When the lottery using two dice slots has ended (“YES” in step S16), the controller 70 will move the first playing piece by the number of steps corresponding to the total dice roll result (step S17). Next, the controller 70 determines whether the first playing piece has landed on the “Chance” space (step S18). If the first playing piece lands on the “Chance” space (YES in step S18), the controller 70 will start a first roulette lottery in the first Monopoly game (step S19).

### Steps S20, S21, S22, and S23

Next, the controller 70 determines whether the first roulette lottery resulted in a “Challenge” (step S20). If the first playing piece lands on the “Challenge” space (“YES” in step S20), the controller 70 will start a second roulette lottery (step S21). Next, the controller 70 will determine whether the player won the “Big Monopoly” in the second roulette lottery (Step S22). If the player won the “Big Monopoly” (“YES” in step S22), the controller 70 will start the second Monopoly game and the dice lottery game (step S23).

### Steps S24, S25, and S26

After the dice lottery game begins, the controller 70 will determine whether the player has pressed the operation button 54 (step S24). If the player has not pressed the operation button 54 (“NO” in step S24), the controller 70 will determine whether the time for which the rotary disk 43 continues to rotate has elapsed (step S25). If the time during which the rotary disk 43 continues to rotate has elapsed (“YES” in step S25), the controller 70 will stop the rotation of the rotary disk 43, recognize the dice roll result of the dice, and then, based on the total dice roll result shown on the recognized two dice 46, move the second playing piece by the number of steps corresponding to that total dice roll result (step S26).

### Steps S27, S28, S29, and S30

Next, the controller 70 will determines whether the dice lottery game has reached a predetermined number of lotteries (step S27). If the dice lottery game has not reached the predetermined number of lotteries (“NO” in step S27), the controller 70 will determine whether the second piece has landed on the “Jail” space (step S28). If the second playing piece does not land on the “jail” space (“NO” in step S28), the controller 70 will determines whether the player has accrued a predetermined number of points in the second Monopoly game (step S29). When the player has accrued a predetermined number of points (“YES” in step S29), the controller 70 will move the medal dispenser 34 above the medal game unit 10 used by the player such that the player can win a jackpot, and then dispense a predetermined number of medals to the player (step S30).

### Steps S31 and S32

Subsequently, the controller 70 determines whether the medal dispenser 34 has completed dispensing medals to the player (Step S31). When the dispensing of medals to the player by the medal dispenser 34 is complete (Step S31 YES), the controller 70 will end the second Monopoly game (Step S32) and then end the game.

On the other hand, if the player has not pressed the medal insertion button 53 (“NO” in step S12), the controller 70 will return the process to step S12. If the lottery medium placed on the placement surface 12 has not fallen into the drop section 14 (Step S14 NO), the controller 70 returns the process to Step S14.

On the other hand, if the lottery using the two dice slots has not yet ended (“NO” in step S16), the controller 70 will return the process to step S16. If the first playing piece has not has not landed on the “Chance” space (“NO” in step S18), the controller 70 will return the process to step S14.

In contrast, if the player does not win the “Challenge” in the first roulette lottery (“NO” in step S20), the controller 70 will determine whether the number of “winning spaces” accumulated in the “Monopoly Challenge” has reached a predetermined amount (step S33). When the number of “winning spaces” accumulated in the “Monopoly Challenge” reaches a predetermined amount (“YES” in step S33), the controller 70 will advance the process to step S23. In contrast, if the number of “winning spaces” accumulated in the “Monopoly Challenge” does not reach the predetermined amount (“NO” in step S33), the controller 70 will return the process to step S14. If the player did not win the “Big Monopoly” (“NO” in step S22), the controller 70 will return the process to step S14.

In contrast, if the player presses the operation button 54 (“YES” in step S24), the controller 70 will advance the process to step S26. When the dice lottery game reaches the predetermined number of lotteries (“YES” in step S27) or when the second playing piece lands on the “Jail” space (“YES” in step S28), the controller 70 will advance the process to step S31. If the player has not accrued the required points (“NO” in step S29), the controller 70 will return the process to step S23. If the dispensing of medals to the player by the medal dispenser 34 has not been completed (“NO” in step S31), the controller 70 will return the process to step S31.

The dice lottery unit 40, which is one example of the lottery device according to the embodiments described above, comprises: dice 46 which are one example of a lottery medium having a lottery surface on which the lottery contents for the lottery are displayed, a rotary disk 43 on which the two dice 46 is placed, and a rotary driver 44 configured to cause the dice 46 placed on the rotary disk 43 to roll on the rotary disk 43 by rotating the rotary disk 43, the rotary disk 43 having a first surface 431 and a second surface 432 along which two dice 46 can roll and stop after the rotation of the rotary disk 43 stops, when the rotary disk 43 is viewed in plan view, the first surface 431 is annular and the second surface 432 is a portion located on the inner side of the first surface 431, and the first surface 431 and the second surface 432 have different configurations such that the force applied by the first surface 431 to the rolling dice 46 is different from the force applied by the second surface 432 to the rolling dice 46. As a result, it is possible to increase players'sense of expectation for the lottery and the amusement in the lottery game by using a simple configuration to vary the movement of the dice 46 on the rotary disk 43 and extend the time the dice 46 roll on the rotary disk 43.

Furthermore, in the dice lottery unit 40 according to the embodiments described above, the force that the first surface 431 applies to the dice 46 to roll them can be made greater than the force that the second surface 432 applies to the dice 46 while they are rolling.

As a result, when the first surface 431 and the second surface 432 are rotating, the rolling time of the dice 46 on the first surface 431 can be made longer than the rolling time of the dice 46 on the second surface 432.

In the dice lottery unit 40 according to the embodiments described above, the first surface 431 can have at least one of the following characteristics: including concave parts; including convex parts; and being made of a material with high friction. As a result, the frictional force that the first surface 431 applies on the dice 46 can be increased compared to a surface portion that does not have any concave or convex portions or a surface portion that is made of a material with low friction.

In the dice lottery unit 40 according to the embodiments described above, the first surface 431 can have an inverted truncated cone shape. As a result, the dice 46 can roll toward the inside of the first surface 431 by means of its own weight by using a simple configuration.

In the dice lottery unit 40 according to the embodiments described above, the second surface 432 may have a annular-shaped connection part 433 connected to the first surface 431 and a circular center part 434 located on the inner periphery of the connection part 433, the connection part 433 may have an inverted truncated cone shape, and the center part 434 can have any one of the following shapes: a flat surface; a spherical surface; and a conical surface. As a result, it is possible to easily realize the dice 46 gathering toward the center part 434 side by means of their own weight.

Furthermore, in the dice lottery unit 40 according to the embodiments described above, the rotary disk 43 can additionally have protrusions 435 provided at its central part 434. As a result, the dice 46 are less likely to gather toward the center part 434 side, making it less likely for the dice 46 to stack on top of each other.

In the dice lottery unit 40 according to the embodiments described above, when the rotary disk 43 is viewed from the side, the inclination of the connection part 433 may be the same as the inclination of the first surface 431, or may be smaller than the inclination of the first surface 431. As a result, by using a simple configuration, the effect of the dice 46's own weight on their rolling on the second surface 432 can be made equal to or less than the effect of the weight of the dice 46 on their rolling at the first surface 431, thereby enabling changes to be made to the movement of the dice 46.

In the dice lottery unit 40 according to the embodiments described above, the dice 46 may have a plurality of lottery surfaces 46S and a plurality of curved surfaces 46C provided around the circumference of each of the plurality of lottery surfaces 46S, and the plurality of curved surfaces 46C may be interconnected and uniformly distributed on the surface of a single sphere. As a result, the rolling time of the dice 46 can be extended compared to dice 46 in which a plurality of curved surfaces are not uniformly distributed on the surface of one sphere.

Furthermore, in the dice lottery unit 40 according to the embodiments described above, each of the plurality of lottery surfaces 46S can be a flat surface or a spherical surface having a curvature smaller than that of a single sphere on which the plurality of curved surfaces 46C are located. As a result, the effect of the lottery surface 46S on the rolling of the dice 46 can be reduced.

The game machine 1A, which is an example of the game machine according to the embodiments described above, comprises at least: a first game unit 20 configured to execute a first Monopoly game as an example of a first game; a second game unit 30 configured to execute a second Monopoly game as an example of a second game; a dice lottery unit 40 configured to execute a dice lottery game associated with the first Monopoly game and the second Monopoly game; and a controller 70 that controls the first game unit 20, the second game unit 30, and the dice lottery unit 40 so as to: start the first Monopoly game by controlling the first game unit 20 in based on a player's operation and acquire the game result of the first Monopoly game; start the dice lottery game by controlling the dice lottery unit 40 based on the game result to obtain the lottery result; and then start the second Monopoly game by controlling the second game unit 30 based on the lottery result. As a result, by using a simple configuration to extend the time of the dice lottery game, it is possible to increase players' sense of expectation for the lottery and the amusement in the lottery game.

The present invention is not limited to any of the above embodiments, and any design modifications made by those skilled in the art to these embodiments are also included within the scope of the idea of the present invention, provided they possess the features of the present invention. That is, the elements provided in the above-described embodiments and their arrangement, materials, conditions, shapes, sizes, or the like are not limited to the exemplified embodiments, but can be modified as appropriate. Furthermore, the elements of each of the above-described embodiments can be combined to the extent technically possible, and such combinations are also included within the scope of the idea of the present invention, provided they possess the features of the present invention. For example, even if the dice lottery unit 40 having the above-described characteristics are used in a game machine that plays a game different from the game played by the game machine 1 according to one or more embodiments, it is still included within the scope of the idea of the present invention. Furthermore, even if the dice 46 (lottery medium) having the above-described characteristics are employed in a lottery device other than the above-described dice lottery unit 40, or is used in a game other than the above-described dice lottery game, it is still included within the scope of the idea of the present invention.

### DESCRIPTION OF REFERENCE NUMERALS

1 . . . Game machine
20 . . . First game unit
30 . . . Second game unit
40 . . . Dice lottery unit
43 . . . Rotary disk
44 . . . Rotary driver
46 . . . Dice
46S . . . Lottery surface
46C . . . Curved surface
431 . . . First surface
432 . . . Second surface
433 . . . Connection part
434 . . . Center part
435 . . . Protrusion
4311 . . . Convex part
4312 . . . Concave part

What is claimed is:

1. A lottery device comprising:
a lottery medium that includes at least one lottery surface on which a lottery content is displayed;
a rotary disk on which the lottery medium is placed; and
a rotary driver that rotates the rotary disk such that the lottery medium rolls on the rotary disk, wherein
the rotary disk has a first surface and a second surface where the lottery medium stops after rolling at time when the rotary disk stops rotating,
when viewed from above, the first surface has an annular shape, and the second surface is disposed on an inner side of the annular shape of the first surface, and
the first surface and the second surface have different configurations such that the first surface applies a first force to the lottery medium during the rolling, the first force being different from a second force that the second surface applies to the lottery medium during the rolling.

2. The lottery device according to claim 1, wherein
the first force applied by the first surface is greater than the second force applied by the second surface.

3. The lottery device according to claim 2, wherein
the first surface has at least one of following characteristics:
including a concave part;
including a convex part; and
being made of a material with high friction.

4. The lottery device according to claim 3, wherein
the first surface has an inverted truncated cone shape.

5. The lottery device according to claim 4, wherein
the second surface has:
an annular connection part connected to the first surface; and
a circular center part disposed on an inner side of the annular connection part, wherein
the annular connection part has an inverted truncated cone shape, and
the circular center part has a flat, spherical, or conical shape.

6. The lottery device according to claim 5, wherein
the rotary disk further has a protrusion disposed in the circular center part.

7. The lottery device according to claim 6, wherein
when viewed from a side, the annular connection part has a degree of inclination that is same as or smaller than a degree of inclination of the first surface.

8. The lottery device according to claim 1, wherein
the lottery medium has:
a plurality of lottery surfaces on which lottery contents are respectively displayed; and
a plurality of curved surfaces disposed around the lottery surfaces, and
the curved surfaces are interconnected and uniformly distributed on a surface of a single sphere.

9. The lottery device according to claim 8, wherein
each of the lottery surfaces is a flat surface or a spherical surface having a curvature smaller than a curvature of the single sphere.

10. A game machine comprising:
a game unit that executes a first game and a second game;
the lottery device according to claim 1 that executes a lottery game related to the first game and the second game; and
a controller that
causes the game unit to start the first game based on a player's operation and obtains a game result of the first game,
causes the lottery device to start the lottery game based on the game result and obtains a lottery result, and
causes the game unit to start the second game based on the lottery result.
